(19) United States
(12) Patent Application Publication
(10) Pub. No.: US 2022/0122479 A1
(43) Pub. Date: Apr. 21, 2022

(54) LEARNING & MOTIVATION BOOSTER APPLICATION

(71) Applicant: Frank Appiah, Greenwood Village, CO (US)

(72) Inventor: Frank Appiah, Greenwood Village, CO (US)

(21) Appl. No.: 17/072,074

(22) Filed: Oct. 16, 2020

(51) Int. Cl. G09B 7/02; G06F 3/14; G10L 15/26; G06F 3/16; G10L 15/22

(52) U.S. Cl. CPC G09B 7/02; G06F 3/14; G10L 15/22; G06F 3/167; G10L 15/26

(57) ABSTRACT

A learning and motivation booster application for posing questions and taking inputs from user's in response to the questions; designed to provide rewards to user's in the form of movies and video games that can only be assessed when a user specified threshold/rules/objectives is achieved and, depending on the correctness of the user's responses. The first part of the apparatus comprise of computing and application devices that receive inputs and converts them to machine readable codes considered as users' response. It then compares those responses to existing correct responses. The second part comprise of devices that stores questions and answers which can be activated by the first set of devices to display to the user. The third part of the apparatus consist of an entertainment database and all other potential entertaining devices and software with contents to reward users based on the correctness of their inputs/responses.

### BACKGROUND

### 1. Field

The present general inventive concept relates generally to a learning and motivation booster application software (app).

### 2. Description of the Related Art

When students/learners stay at home for longer periods of time, such as the periods witnessed during Covid-19 lockdown, there's a need to keep them motivated. Caregivers, parents and adult supervisors struggle to keep students/learners focused on learning and motivated at the same time, absent of frustrations. Currently on the market, there are apps that help students learn such as ‘Integrated Leaning App’ (U.S. Pat. No. 9,467,520) but they lack the ability to incorporate rules, objectives, thresholds and motivations that can be managed directly by parents, adult supervisors and or caregivers.

Therefore, there is a need for an app that combines learning and motivation and allows users (parents/caregivers) to set objectives for their students and learners.

### SUMMARY

The present general inventive concept provides a learning and motivation app for students and learners.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a . . .

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 Illustrates a system to load problems to an app for students to complete and a reward mechanism that automatically makes available to the student/learner a movie and or games database connected to the app, when the student/learner meets a preassigned objectives and threshold/rules/objectives set forth by the parent/adult/caregiver, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. The figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to term deviating from a meaning commonly understood by one of ordinary skill, this meaning is to be taken into account in the specific context this definition is given herein.

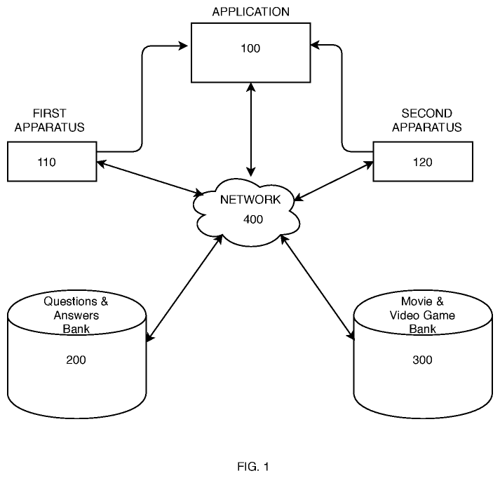

FIG. 1 illustrates a system 100 that displays outputs from processed inputs received via connected apparatus or systems in the form of questions and answers, threshold/rules/objectives to be met by students according to an exemplary embodiment of the present general inventive concept and rewards.

The system 100 may include a first apparatus 110, a second apparatus 120, questions and answers database 200, a network 400 and a movie and video game database (also referred to as entertainment database) 300, but is not limited thereto, nor are all the components thereof described herein.

The first apparatus 110 may include a computing, a device that may receive input, transmit data, receive data, access the Internet, provide global positioning services (GPS), and communicate with other devices or systems via a network, and may include a desktop computer, a laptop computer, a tablet computer, and/or a mobile device, such as a cellular phone or a smart phone, but is not limited thereto.

The second apparatus 120 may include a computing device that may receive input, convert voice input to text, transmit data, receive data, access the Internet, provide global positioning services (GPS), and communicate with other devices or systems via a network, and may include a desktop computer, a laptop computer, a tablet computer, and/or a mobile device, such as a cellular phone or a smart phone, but is not limited thereto.

The first apparatus 110 may access the Internet to allow a user to access a website, and/or may allow a program and/or application to be executed thereon. The application may be designed to randomly sample questions and answers from the questions and answers bank 200 that may be displayed on a screen to request inputs from apparatus 120 in response to the questions. That is apparatus 110 draws and displays random questions and apparatus 120 accepts users input in response to the random questions.

For ease of description, the first apparatus 110 will be hereinafter interpreted to be an app device, desktop or laptop, and the second apparatus 120 will be hereinafter interpreted to be a desktop computer or laptop or app.

The first apparatus 110 may include an input unit such as a keyboard/keypad to allow the user to input data to be displayed by 100 through typing or punching in numbers/letters. The second apparatus 120 may include an input unit that will allow the user to input data into 100 by speaking into or near the input unit 120. A processor embedded in unit 120 will convert the input voice data into text for display on a screen which is part of apparatus 100. The processor in 110 may also include or may be connected to a storage unit to store the audio data and/or the converted text data, a central processing unit to process any type of data, and a communication unit to receive and/or transmit any type of data via the network 400. Apparatus 110 may also include a display unit to display the data thereon, and a touch screen and/or keyboard/keypad to allow further input of data into the first apparatus 100.

The second apparatus 120 may include a microphone, to allow the user to input data into apparatus 100 by speaking into or near the input unit 120, which also may have a processor to convert the input audio or otherwise into text data or numeric data that is specifically formatted for display by apparatus 100.

As such, the user (e.g., a student) may begin speaking or typing on a keyboard or pad in response to questions randomly generated from unit 200 after being triggered by apparatus 110, and the second apparatus 120 may begin automatically recording the input (e.g. voice, texts, digits) of the user. The processor embedded in unit 120 may convert the input audio data into interpretable computer code that is specifically formatted for displaying the expected output which is an answer in response to the randomly generated questions from the questions from apparatus 200. Apparatus 100 has the capability to score users input by comparing them with coded solution stored in the questions and answers bank 200.

Depending on user's score, a reward score is assigned and displayed by apparatus 100 and automatically kicks off a pre-assigned movie or video game from apparatus 300 that corresponds to the user's achieved score. The contents of units 200 and 300 are updated and populated by third party vendors that offer educational and entertainment services.

Referring to FIG. 1, the network 400 may be at least one of the Internet, a cellular network, a universal mobile telecommunications systems (UMTS) network, a Long Term Evolution (LTE) network, a Global System for Mobile Communications (GSM) network, a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. The network 400 can be implemented with any number of hardware and software components, transmission media, and network protocols. FIG. 1 illustrates the network 400 as a single network, but is not limited thereto.

The first apparatus 110 and the second apparatus 120 can both send data to, and receive data from each other over the Internet or any of the above-mentioned networks. The first apparatus 110 and the second apparatus 120 can be directly coupled to the output displayed by apparatus 100. Alternatively, the first apparatus 110 and the second apparatus 120 can be connected to the information displayed by apparatus 100 via any other suitable device, communication network, or combination thereof. For example, the first apparatus 110 can be coupled to the output shown by apparatus 100 via routers, switches, access points, and/or communication networks. In other words, the output displayed by apparatus 100, the apparatus 110, and the apparatus 120 may all communicate with each other via the network 400.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A learning and motivation booster application apparatus that displays questions, take responses and provide motivational/rewarding opportunities to users.

2. An apparatus that accepts input units that are either digital/text in nature or voice of user. Thus, it accepts all forms of data.

3. An apparatus that allows users to set rules, objectives, thresholds etc. to be met by student/learner.

4. An apparatus that generates questions and displays them on a screen.

5. An apparatus that converts user's voice into a text.

6. An apparatus that converts user's inputs as responses to be further evaluated downstream.

7. An apparatus that checks user's response with existing solutions for correctness.

8. An apparatus that provides reward depending on the correctness of user's response(s).
